(19) United States
(12) Patent Application Publication
(10) Pub. No.: US 2011/0132555 A1
(43) Pub. Date: Jun. 9, 2011

(54) WINDOW SHADE SAFETY SYSTEM

(75) Inventors: John Rowley, Gastonia, NC (US); Min Ye, (US)

(73) Assignee: Rowley Company, LLC

(21) Appl. No.: 12/961,788

(22) Filed: Dec. 7, 2010

Related U.S. Application Data
(60) Provisional application No. 61/267,195, filed on Dec. 7, 2009.

(51) Int. Cl. A47H 5/02; B23P 11/00

(52) U.S. Cl. 160/340; 29/428

(57) ABSTRACT

A window shade having a lift cord that is partially or entirely contained within a tape. Preferably, the tape is made of fabric or cloth. In a first embodiment, the tape portion of the window shade is made of a cloth that is woven to form a tube. The lift cord or cords of any window shade are contained within the hollow portion of the tube. Additionally, the cloth tape is spot stitched to the window shade at a spacing small enough to prevent the entry of a head of a child, person, or pet. As a lowered shade is raised by the lift cord, the lift cord tape tightly gathers so as to prevent the formation of loops, or at least loops large enough to engulf a head.

### CROSS REFERENCE TO RELATED APPLICATIONS

The present application claims the benefit of priority of U.S. Provisional Application No. 61/267,195, filed on Dec. 7, 2009.

### BACKGROUND OF THE INVENTION

The present invention relates generally to safety features for window shades, and, in particular, to an apparatus and method for imparting a safety feature for window shades with lift cords.

The use of window shades or coverings in residential and commercial settings is the preferred choice to control privacy and the natural light entering a space, as well as to create an aesthetically pleasing appearance within the space. In addition to the appearance and effectiveness of window shades, a significant consideration in choosing a window shade is whether it is sufficiently safe to avoid unforeseen accidents and danger to those operating the shade, as well as to those that come into contact with the window shade who are more vulnerable and prone to accidents, such as children or pets. In fact, among reported cases in the past 12 years, over 200 infant deaths may have been attributed to window shade related incidents.

Even a single death is too many when it could have been avoided through adequate safety measures. One of the greatest dangers presented by conventional window shades includes the failure to shield or contain the lift cords connected to the window shades. Loose or free lift cords have the potential to become entangled and wrapped around those who come into contact with them. Thus far, this area of potential danger remains largely unaddressed among conventional window shades. Moreover, recalls on these types of window coverings for safety reasons are not only commonplace, but they are occurring on a rapidly increasing basis.

The classic window shade includes lift cords or lift tapes running down through columns of rings that are sewn to the back of the window shade. As the lift cord is pulled on a lowered shade, the shade will raise and form layers or tiers. If the lift cord is free other than its connection to the rings, a cord could be pulled to form a loop. These loops can potentially become dangerous, if not deadly, if one becomes entangled within them such as by placing one's head within the loop.

Accordingly, there remains a need for an improved apparatus and method that provides a convenient and effective means to protect the lift cords of window shades from unintended uses and accidents.

### SUMMARY OF THE INVENTION

The following presents a simplified summary of the invention in order to provide a basic understanding of some aspects of the invention. This summary is not an extensive overview of the invention. It is not intended to identify key or critical elements of the invention or to delineate the scope of the invention; its sole purpose is to present concepts of the invention in a simplified form as a prelude to the more detailed description that is subsequently presented.

According to its major aspects and briefly stated, the present invention includes a window shade having a lift cord that is partially or entirely contained within a lift cord tape or enclosure that is referred to herein generally as a “tape.” As used herein, “window shade” refers to a Roman-like or cord-lifted window shade, which includes rings, loops or other means through which lift cords or lift tapes can slide. These types of shades include, but are not limited to Roman, woven, wood, hobbled, cloud and Austrian style shades.

The tape of the present invention can be made of fabric, cloth, plastic film or nonwoven fabric, as well as other suitable materials. In a first embodiment, the tape portion of the window shade is made of a cloth that is woven to form a tube. The lift cord or cords of any window shade are contained within the hollow portion of the tube. Additionally, the cloth tape is entirely stitched or spot stitched to the window shade at a spacing small enough to prevent the entry of a head of a child, person, or pet, which would comply with proposed industry guidelines. As a lowered shade is raised by the lift cord, the tape tightly gathers or shirrs, yet the lift cords are concealed so as to prevent the formation of loops, or at least loops large enough to receive and engulf the head of an infant or person.

In an alternative embodiment, the tape includes a single layer of cloth that is generally flat and not formed into a tube. In this embodiment, a lift cord is loosely woven down the length of the tape so that when the lift cord is pulled or retracted, the tape will shirr to a shape resembling ribbon candy. While some loops are formed by the exposed portions of the lift cord, these loops are not large enough to contain the head of an infant or person.

In another alternative embodiment, the tape or the lift cord or both the tape and the lift cord include a coating to facilitate in the operation of the window shade. Compression of the tape when the shade is raised is critical for proper shade function and appearance. Compression and ease of raising the shade is enhanced by reducing friction of the cord in movement relative to the tape as the shade is raised.

The coating to either the tape or the lift cord could be applied in the yarn state prior to manufacturing, or, alternatively, after the cord or tape is manufactured. Several coatings could be used including but not limited to petroleum based coatings such as wax or paraffin derived coatings. Other friction reducing coatings include fluoropolymer coatings. Additional coatings are anticipated.

In yet another alternative embodiment, the lift cord and the tape can be made of different types of material compositions or fibers that reduce the friction between them. Surfaces of similar materials generally have increased tendency to grip or gouge each other when in sliding contact. As an example, but not by way of limitation, the cord can be made of polyester and the contact surface of the tape can be made of nylon or another suitable material other than polyester.

In still another embodiment, the tape of the present invention can be made of a translucent material. While some window shades are opaque to sunlight, others are constructed from translucent fabric. If translucent fabrics are used, care must be taken to avoid materials that create the appearance of an obvious shadow when viewed on the interior side of the shade during a sunny day. Furthermore a translucent tape is also less visible through the window from the exterior of the structure. Alternatively, the tape construction can include the use of a mono-filament yarn or strands. This type of construction results in a significantly less visible tape from interior and exterior sides of the shade.

Additional embodiments are also contemplated by the present invention, including an embodiment that employs a twill tape that covers or partially covers a lift cord. Additionally, rings or loops can be sewn or weaved into the tape for added reinforcement.

A feature of the present invention is the use of a tape that partially or entirely engulfs a lift cord of a window shade so as to prevent the formation of loops large enough to contain or receive the head of an infant or person. The tape also reduces a chanced access to the lift cord by a child or pet.

Another feature of the present invention is the use of a tape and lift cord that are constructed so as to minimize the friction between them during the operation of a window shade. By including different materials or surface coatings to the lift cord and tape, the friction between these features can be reduced.

Other features and their advantages will be readily apparent to those skilled in decorative arts, techniques and equipment from a careful reading of the Detailed Description of Preferred Embodiments, accompanied by the following drawings.

### BRIEF DESCRIPTION OF THE DRAWINGS

FIG. 1A includes a rear view of a lift cord shade system wherein the shade is lowered according to an embodiment of the present invention;

FIG. 1B includes a rear view of a lift cord shade system wherein the shade is drawn up according to an embodiment of the present invention;

FIG. 2A is a perspective view of a tape and a lift cord according to an embodiment of the present invention;

FIG. 2B is a perspective view of a tape and a lift cord according to an embodiment of the present invention;

FIG. 3 is a perspective view of a tape and a lift cord according to an embodiment of the present invention;

FIG. 4 is a perspective view of a tape and a lift cord according to an embodiment of the present invention;

FIG. 5A is a perspective view of a tape and a lift cord according to an embodiment of the present invention;

FIG. 5B is a perspective view of a tape and a lift cord according to an embodiment of the present invention;

FIG. 6A is a perspective view of a tape and a lift cord according to an embodiment of the present invention;

FIG. 6B is a perspective view of a tape and a lift cord according to an embodiment of the present invention;

FIG. 7 is a perspective view of a tape and a lift cord according to an embodiment of the present invention.

### DETAILED DISCLOSURE OF THE PREFERRED EMBODIMENT

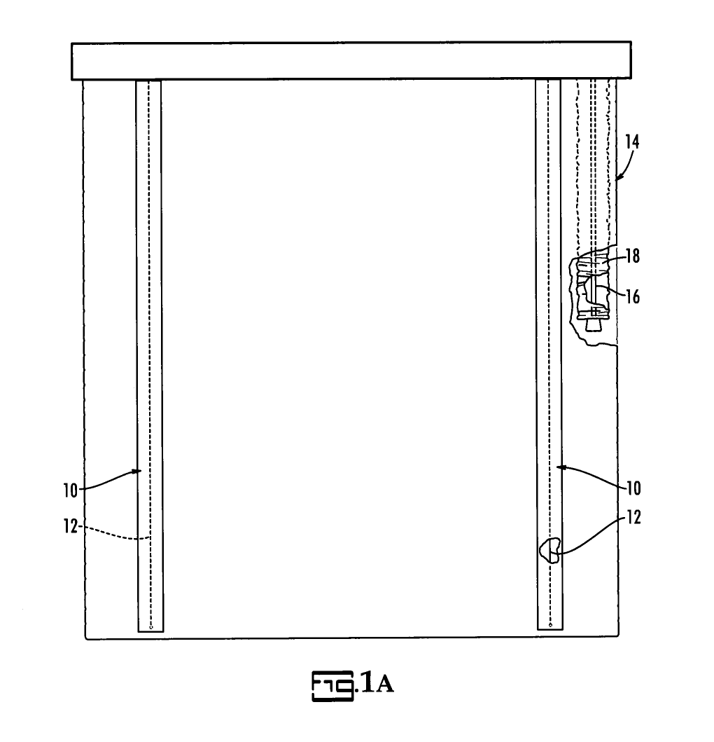

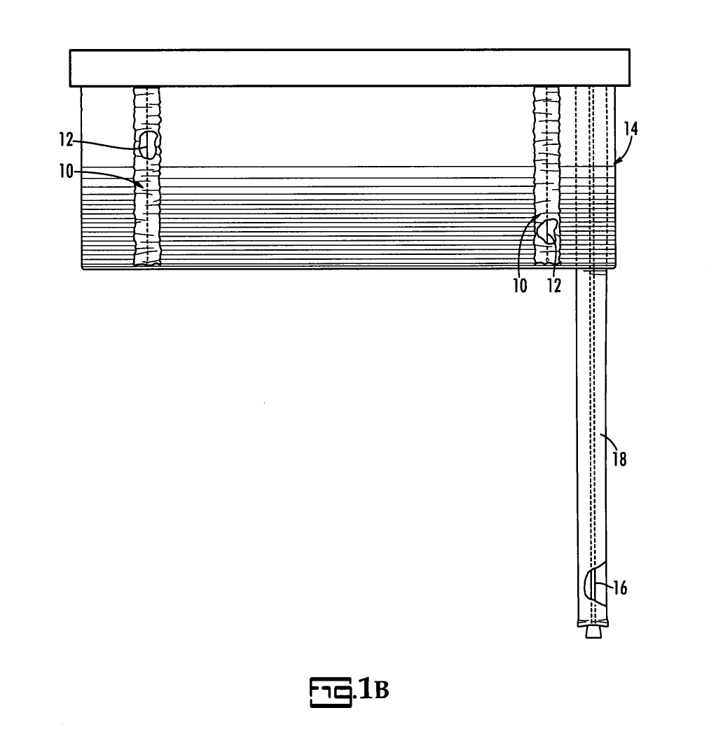

The present invention includes a system, apparatus and method for imparting safety to a window shade. Alternative embodiments of the present invention are shown in FIGS. 1-5. In particular, the present system includes a window shade 14 having a lift cord 12 that is partially or entirely contained within a lift cord tape and is referred to herein as simply a tape 10. As used herein, “window shade” refers to a Roman-like or cord-lifted window shade, which includes rings, loops or other means through which lift cords or lift tapes can slide. These types of shades include, but are not limited to, Roman, woven, wood, hobbled, cloud and Austrian style shades.

In one embodiment, shown in FIGS. 1A-1B, features of the window shade 14 are shown so as to place the tape 10 and lift cord 12 of the present invention into context. It is thus within the purview of the present invention to combine the tape 10 and lift cord 12 with other window shades having a variety of features and dimensions.

As illustrated, the window shade 14 includes lift cords 12, which can vary in number, that are partially or entirely contained within tape 10. Additionally, the window shade 14 system can include a drive cord 16 that engages the lift cords 12 so as to raise and lower the window shade 14.

The tape 10 can be secured to the window shade 14 by a variety of means. For example, the tape 10 can be sewn to the window shade 14 along the entire length of the tape or only spot stitched to the window shade 14 in spaced apart increments along the tape 10. Furthermore, the tape can be adhered to the surface of the window shade through the use of an adhesive material. Similarly, the adhesive can be applied along the entire length of the tape 10 or only at spaced apart portions of the tape 10.

In operation, the lift cords 12 remain at least partially, if not completely covered when the window shade is either in a lowered or raised position. The tape 10 will appear generally flat or smooth when the window shade is lowered or completely down in relation to the window being covered. When the window shade 14 is drawn up, the tape 10 of the lift cords 12 will appear crinkled or puckered.

In one embodiment, the drive cord 16 of the present invention can also include a tape cover 18. As shown, the drive cord 16 could be contained within a tape cover 18. Because the tape cover 18 of the drive cord 16 would not be directly anchored to the window shade 14, the tape cover could be weighted to assist in maintaining the drive cord 16 covered until engaged. This tape cover 18 could be lifted to reveal the drive cord 16 if and when the drive cord 16 is engaged to raise or lower the window shade 14. Alternatively, the tape cover 18 will become extended or puckered depending on the raising and lowering of the drive cord 16.

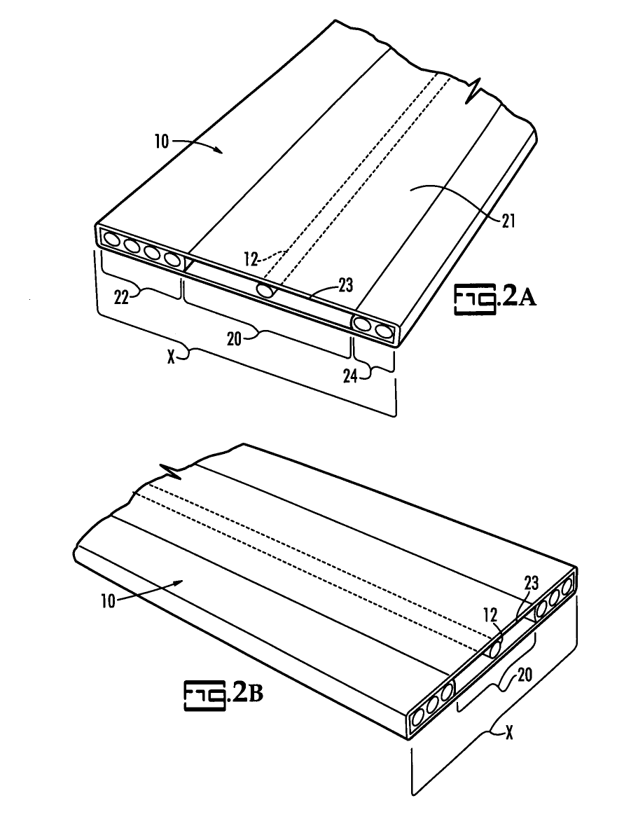

The tape 10 of the present invention can be made from a variety of materials, including fabric, cloth, or non-woven materials, including plastic. The tape 10 can also include a number of features and dimensions. In embodiments, shown in FIGS. 2A-2B, the tape portion of the window shade is made of a cloth that is woven and/or knitted to form a tube 20 having a top layer 21 and a bottom layer 23. The lift cord 12 or cords of the window shade 14 are contained within the hollow portion of the tube 20 and extends the length of the tape 10.

Although other dimensions and structures are contemplated, an example construction of 10 tape is shown in FIG. 2A. In particular, the tape 10 is made of woven and/or knitted fabric. The tape 10 includes a first edge 22 that includes a sew tab having a width of approximately 4 or 5 ends at one side of the tape 10 and a second edge 24 including a sew tab of approximately 2 ends at the opposing side of the tape 10. Between these sew tabs is the hollow tube 20 area formed by loosely or tightly woven fibers having a width equal to about 9 ends and including a top and bottom layer, 21, 23. In total, the width X of the tape is about 1″ or less. However, other sizes and dimensions for the tape 10 and its features are contemplated.

Alternatively, as shown in FIG. 2B, the tape 10 can include opposing edges, 24, 26 having sew tabs of approximately the same width on either side of the tape 10 along its length. Between these sew tabs is the hollow tube 20 area formed by loosely or tightly woven fibers having a width equal to about 9 ends and including a top and bottom layer, 21, 23. In total, the tape 10 can have a width X of about 1 inch or less. However, other sizes and dimensions for the tape 10 and its features are contemplated.

The tape could also be a mesh, open weave or knit construction. Additionally, a sew tab can be located in other areas than the opposing side edges of the tape 10. For example, a sew tab can be located along only one of the side edges of the tape 10. The sew tab can be bordered by a hollow tube in more than one area. For example, a sew tab can be flanked on either side by a hollow tube. Other alternative arrangements including a sew tab and a tube of the tape 10 are also contemplated.

The sew tabs as described can be employed to attach or connect the tape 10 of the present invention to a window shade 14. For example, the tape 10 can be spot tacked or spot stitched along the sew tabs to a surface of a window shade 14. Alternatively, the tape 10 can be sewn or tacked continuously along the length of the sew tabs 10 to a window shade 14. To the extent that the tape 10 is spot tacked or stitched, the spacing between the areas of attachment of the tape 10 to the window shade 14 are at least small enough to prevent the entry of a head of a child, person, or pet. For example, the tape 10 can be spot tacked at spaced intervals of about 6 inches.

In operation, the tape 10 of FIGS. 2A-2B will tightly gather or shirr when a lowered window shade 14 is raised by the lift cords 12, yet the lift cords 12 remain concealed so as to prevent the formation of loops, or at least loops large enough to receive an infant-sized head. When the lift cords 12 are pulled, the hollow area within the tube 20 and the lift cords 12 can be easily compacted. In fact, the compaction allows for the window shade 14 to be lifted to a desired level, such as levels reached by standard window shades.

Whereas the tape 10 of the present invention is connected to the window shade 14, the lift cords 12 within the tape 10 or engaged by the tape 10 are preferably not stitched to or connected to the window shade 14. The more freedom the lift cord 12 has to move within or through the tape 10, the better the compression of the tape 10 and overall operation of the window shade 14.

In another embodiment, shown in FIG. 3, the tape 10 includes a single layer of cloth or woven fabric, as well as plastic film and nonwoven fabric. In this embodiment, the tape 10 is generally flat and not formed into a tube. As shown, the lift cord 12 is loosely woven down the length of the tape 10 from one face 31 of the tape 10 to the opposing face 32 through openings 30 so that when the lift cord 12 is pulled or retracted, the tape 10 will shirr in a zigzag fashion. In particular, when the lift cord is pulled or retracted, the tape 10 will shirr to a shape resembling ribbon candy. While some loops can be formed by the exposed portions of the lift cord 12, these loops are dimensioned so that they are unable to receive or contain the head of a child or person.

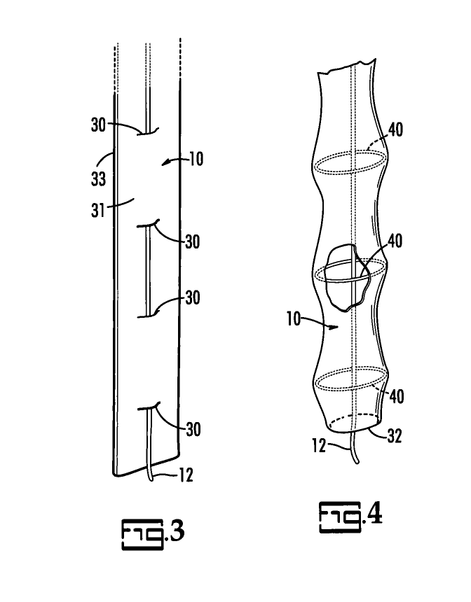

FIG. 4 shows another embodiment of the present invention. As illustrated, the tape 10 is formed into the shape of a tube 32. Thus, the tape 10 surrounds the lift cord 12, which is contained within the hollow portion of the tube 32. Along the length of the tape 10 and within the interior, hollow portion of the tape 32 are included one or more rings 40 that can provide reinforcement to the tape 10. These rings 40 can be sewn to, weaved through or otherwise attached to the tape 10.

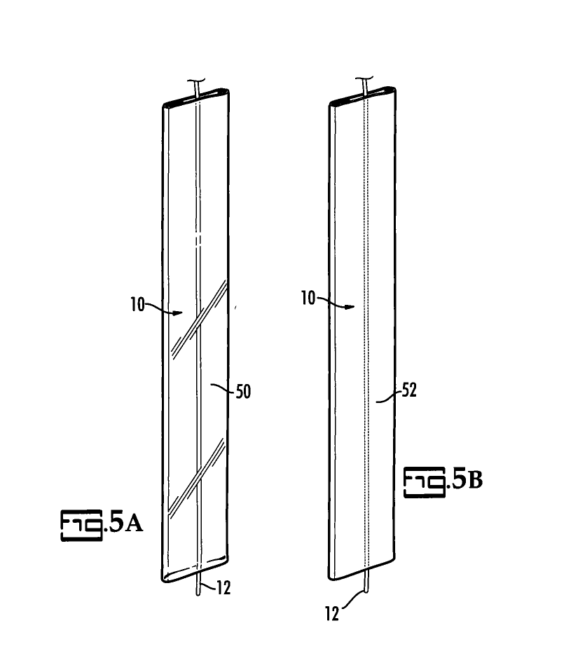

In another embodiment, shown in FIG. 5A, the tape 10 of the present invention can be made of a translucent material 50. FIG. 5B shows the tape 10 formed with an opaque material 52 by comparison. While some window shades are opaque to sunlight, others are constructed from translucent fabric. If translucent fabrics are used, care must be taken to avoid materials that create the appearance of an obvious shadow when viewed on the interior side of the shade during a sunny day. Furthermore, translucent tape is also less visible through the window from the exterior of the structure. To achieve a more translucent tape, the tape 10 can be formed using a mono-filament yarn or strand. This type of construction results in a significantly less visible tape from interior and exterior sides of the window shade.

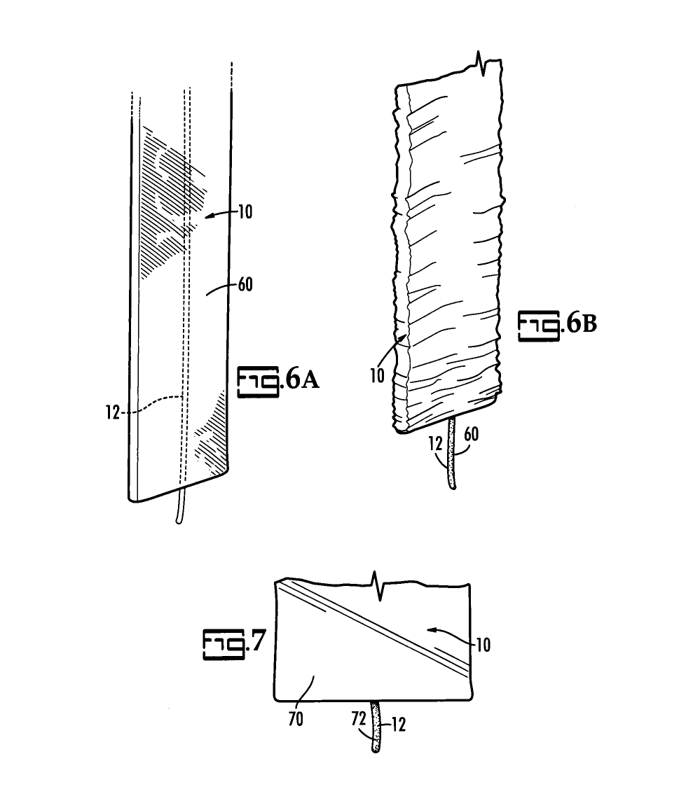

Another embodiment of the tape 10 and lift cord 12 is shown in FIGS. 6A-6B. In particular, the tape 10 or the lift cord 12 or both the tape 10 and the lift cord 12 can include a coating or surface coating 60 to facilitate in the operation of the window shade. Compression of the tape 10 when the window shade is raised is critical for proper shade function and appearance. By applying a coating to the tape 10, the lift cord 12, or both, compression and ease of raising the window shade is enhanced because the friction of the lift cord 12 in movement relative to the tape 12 is reduced as the window shade is raised.

The coating 60 to either the tape 10 or the lift cord 12 could be applied in the yarn state prior to manufacturing. Alternatively, the coating 60 could be applied after the lift cord 12 or tape 10 is manufactured. Several coatings could be used including, but not limited to, petroleum-based coatings such as wax or paraffin derived coatings. Other friction reducing coatings include fluoropolymer coatings. Additional coatings are anticipated.

In another alternative embodiment, the lift cord 12 and the tape 10 can be made of different types of material compositions or fibers that reduce the friction between them when the lift cords are engaged to raise and lower a window shade. Surfaces of similar materials generally have increased tendency to grip or gouge each other when in sliding contact. As an example, but not by way of limitation, the lift cord 12 can be made of polyester 70 and the contact surface of the tape 10 can be made of nylon 72 or another suitable material other than polyester. Other materials, including those having different resin compositions are contemplated by the present invention.

Additional embodiments are also contemplated by the present invention, including an embodiment that employs a twill tape that covers or partially covers a lift cord. Additionally, rings or loops can be sewn or weaved into the tape for added reinforcement.

Additional embodiments are also contemplated by the present invention, including an embodiment that employs a twill tape that engulfs or partially engulfs a lift cord, as well as an embodiment that includes a woven or knitted mesh hollow tube.

While it is important to avoid as much potential for danger as possible, the tape of the present invention need not extend the entire length of the window shade to which it is connected. It is most important to include the tape in areas most likely to invite tampering or manipulation by those vulnerable to its danger. For example, the tape can be attached to the window shade below the head rail of that shade, but at a level high enough to avoid reach by an infant or child.

Those skilled in the art of window shades and the decorative arts will appreciate from the foregoing description of preferred embodiments that substitutions and modification can be made without departing from the spirit and scope of the invention which is defined by the appended claims.

What is claimed is:

1. A lift cord shade system, comprising:
a window shade having a surface;
a tape connected to said surface; and
a lift cord contained at least in part by said tape.

2. The lift cord shade system as recited in claim 1, wherein said lift cord is completely contained by said tape.

3. The lift cord shade system as recited in claim 1, wherein said tape is made of woven or knitted fabric.

4. The lift cord shade system as recited in claim 1, wherein said tape is a woven or knitted tube having a hollow portion that receives said lift cord.

5. The lift cord shade system as recited in claim 1, wherein said tape is made from plastic film or non-woven fabric.

6. The lift cord shade system as recited in claim 1, wherein said tape includes a first side edge and an opposing second side edge, wherein said first side edge includes a first sew tab.

7. The lift cord shade system as recited in claim 6, wherein said second side edge includes a second sew tab.

8. The lift cord shade system as recited in claim 7, wherein said tape includes a tube, and wherein said tube is between said first and second sew tabs.

9. The lift cord shade system as recited in claim 8, wherein said first sew tab has a width of about 4 to 5 ends, and wherein a second sew tab has a width of about 2 ends.

10. The lift cord shade system as recited in claim 6, wherein said tape has a width of about 1″ or less.

11. The lift cord shade system as recited in claim 8, wherein said tube includes a hollow portion that has a width of about 9 ends, and wherein said lift cord is contained within said hollow portion.

12. The lift cord shade system as recited in claim 1, wherein said tape includes an area, wherein said area is suitable for sewing or including a sew tab.

13. The lift cord shade system as recited in claim 1, wherein said tape includes a first face and an opposing second face, and wherein said lift cord is woven from said first face to said second face along the length of said tape.

14. The lift cord shade system as recited in claim 1, wherein said tape includes a plurality of rings or loops that are included within said tape.

15. The lift cord shade system as recited in claim 1, wherein said tape is a twill tape.

16. The lift cord shade system as recited in claim 1, wherein said tape includes a coating for lowering the friction between said tape and said lift cord.

17. The lift cord shade system as recited in claim 16, wherein said lift cord includes said coating.

18. The lift cord shade system as recited in claim 16, wherein said coating is petroleum based

19. The lift cord system as recited in claim 18, wherein said coating is wax or paraffin.

20. The lift cord system as recited in claim 16, wherein said coating is a fluoropolymer.

21. The lift cord system as recited in claim 1, wherein said lift cord and said tape are made of different materials.

22. The lift cord system as recited in claim 21, wherein said lift cord is made of polyester and wherein said tape is made of nylon.

23. The lift cord system as recited in claim 1, wherein said tape is made of a translucent material.

24. The lift cord system as recited in claim 23, wherein said tape is made of mono-filament yarn or strands.

25. A method for imparting safety to a lift cord shade, comprising the steps of:
providing a window shade having a surface, a tape and a lift cord that is at least partially contained by said tape; and
connecting said tape to said surface of said window shade.

26. The method as recited in claim 25, wherein said tape includes a sew tab along its length.

27. The method as recited in claim 26, further comprising the step of spot tacking said sew tab to said surface of said window shade.

28. The method as recited in claim 26, further comprising the step of sewing said sew tab to said surface of said window shade along the entire length of said tape.
